(19) United States
(12) Patent Application Publication
(10) Pub. No.: US 2010/0019478 A1
(43) Pub. Date: Jan. 28, 2010

(54) Stand for a motorcycle

(76) Inventors: Jeffrey B. DuFresne, Temecula, CA (US); Leslie K. DuFresne, Temecula, CA (US)

Correspondence Address: Don E. Erickson, 7668 El Camino Real, Suite 104 #627, La Costa, CA, 92009, US

(21) Appl. No.: 12/220,414

(22) Filed: Jul. 24, 2008

(51) Int. Cl. B60R 27/00

(52) U.S. Cl. 280/755

(57) ABSTRACT

An apparatus for supporting a motorcycle on all terrains, and more particularly, a means of supporting the tire of a motorcycle in an upright position.

### BACKGROUND OF THE INVENTION

Two-wheeled vehicles, such as bicycles or motorcycles, tend to be unstable when they are not in motion. Without some additional support means, such as a kick stand, gravity causes a stationary two-wheeled vehicle to fall over. People who own, transport or service a two-wheeled vehicle often have a need to maintain the vehicle in a substantially vertical position. While a kickstand generally suffices to support the vehicle at rest, the use of a kickstand alone is often inadequate where the vehicle is subject to other forces, such as on uneven or slopping ground. A stationary two-wheeled vehicle on solid ground may even be subjected to external forces by gusting winds or flowing water, for example.

### DESCRIPTION OF RELATED ART

U.S. Pat. No. 6,651,996 to Allemang discloses a support device is provided for supporting a wheeled vehicle, such as a motorcycle, in a substantially upright position on a supporting surface. The support device comprises a wheel engaging section to contact and hold a wheel of the vehicle. The wheel engaging section is coupled to a lateral support beam which contacts the supporting surface to resist tilting of the wheeled vehicle. In one embodiment, the lateral support beam is removable from the wheel engaging section to facilitate storing or transporting the support device

U.S. Pat. No. 5,735,410 to Kallstrom discloses a stand for locking the front wheel of a vehicle, such as a motorcycle, in a stable position. The stand has front and rear support mechanisms which, in a preferred embodiment, are actuated by a ramp so that the weight of the front wheel of the motorcycle as it is rolled onto the ramp will actuate the front and rear supports to engage the tire at locations forward and rearward of the wheel axis of rotation.

Neither of these references disclose a simple, easy to use, support for a motorcycle that may be used on various terrains.

### SUMMARY OF THE INVENTION

The present invention is an apparatus for supporting a motorcycle consisting of at least one pair of support arms for receiving a tire of the motorcycle which connect to a horizontal crosspiece for receiving the support arms. A vertical support member is affixed to the horizontal crosspiece which supports the tire. A horizontal support means affixed to the vertical support member is sized for receipt in a trailer hitch.

### BRIEF DESCRIPTION OF THE DRAWINGS

FIG. 1 discloses a side view of a motorcycle tire supported by the apparatus of the invention.

FIG. 2 is an overhead view of the apparatus of FIG. 1.

FIG. 3 is a overhead view of a second embodiment of the apparatus of the invention.

### DETAILED DESCRIPTION OF THE INVENTION

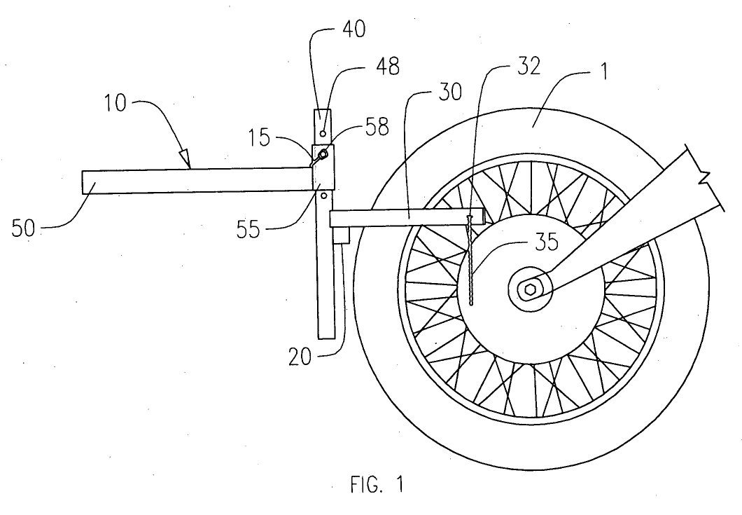

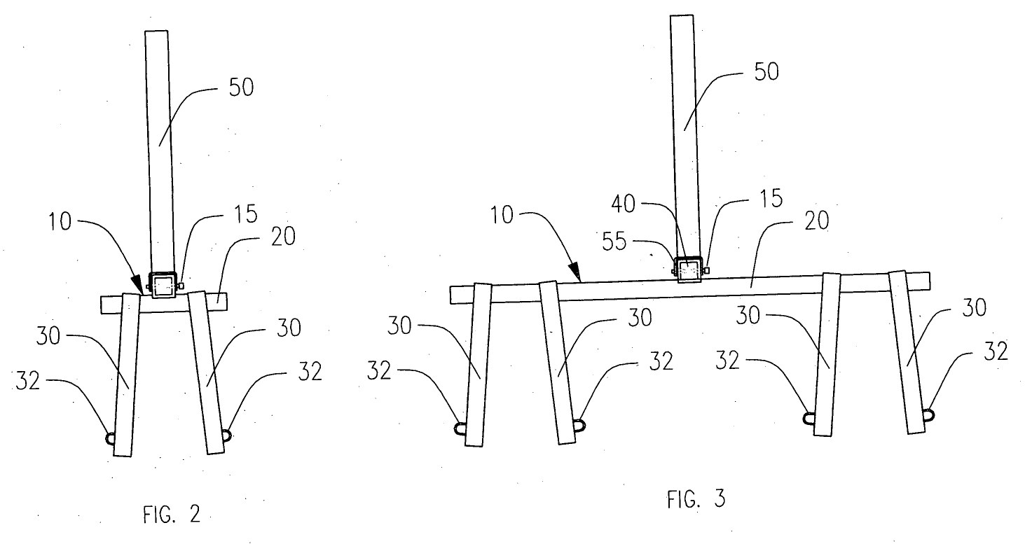

FIG. 1 discloses a side view of the invention 10 supporting the rear tire of a motor cycle. FIGS. 1 and 2 disclose the simplest embodiment of the invention 10 wherein support arms 30 are mounted on crosspiece 20. Crosspiece 20 may be affixed by means of boltholes (not shown) to any structure, such as the frame of a garage. However, in other applications, additional structure is required. Referring again to FIGS. 1 and 2, horizontal support means 50 is attached directly to crosspiece 20. The distal end of horizontal support means 50 is sized to be nestingly received in a trailer hitch mounted on any vehicle. In this embodiment, crosspiece 20 is a 1½ inch solid steel bar of approximately 11 inches in length. Support arms 30 are 1½ inch solid steel bars, and are sized to be permanently mounted on crosspiece 20 such that support arms extend about 11 inches from crosspiece 20. Support arms 30 angle slightly from the perpendicular to crosspiece 20, being mounted approximately 4½ inches at the point of attachment and being about 6½ inches apart at their distal end. The means of mounting support arms 30 to crosspiece 20 is not a limitation of the invention. They may be either welded or bolted to crosspiece 20. Although cross piece 20 and support arms 30 have been described and solid steel bars, they may be constructed of hollow tubing in the interests of reducing weight.

In order to accommodate a variety of vehicles whose trailer hitches may be at differing distances to the ground, vertical support means 55 is permanently affixed to horizontal support 50 to adjustable receive vertical support member 40. Vertical support means 55 is a hollow cylinder of about 6 inches in length which slideably receives vertical support member 40 which moves vertically through vertical support means 55. Vertical support means 40 may also serve as an abutment to tire 1, restraining the motorcycle from rolling. Vertical support means 55 has a through hole 58 drilled perpendicular to the longitudinal axis of horizontal support 50 to receive a 2 inch locking pin 15. Vertical support member 40 is permanently affixed to crosspiece 20, with a plurality of through holes 48 drilled on opposing sides of vertical support member 40 along its vertical axis, parallel to crosspiece 20, and positioned to be aligned with through hole 58. Vertical support member 40 may then be adjusted to any height above the ground by matching through hole 58 to any of the various through holes 48, and inserting lock pin 15.

Motorcycle tire 1 is locked to apparatus 10 by locking means consisting of chain 35 extending through motorcycle tire 1, and attached at either end at eyehooks 32 attached at opposing sides of support arms 30. Alternatively, locking means could consist of a solid bar removably and adjustably mounted between the support arms 30, or by any other means readily apparent to one of ordinary skill in the arts, including locking means attached to crosspiece 20.

A second embodiment of the invention is disclosed in FIG. 3, wherein two sets of support arms 30 are mounted on crosspiece 20 in order to simultaneously support two motorcycles. In this embodiment, crosspiece 20 is approximately 42 inches in length, with approximately 30 inches between each pair of support arms 30. The number of pairs is not a limitation of the invention, and the crosspiece 20 could easily support three pairs of support arms. As with the first embodiment of the invention, vertical support means 55 is permanently affixed to horizontal support 50 to adjustable receive vertical support member 40. Vertical support means 55 is a hollow cylinder of about 6 inches in length which slideably receives vertical support member 40 which moves vertically through vertical support means 55. Vertical support means 40 may also serve as an abutment to tire 1, restraining the motorcycle from rolling. Vertical support means 55 has a through hole 58 drilled perpendicular to the longitudinal axis of horizontal support 50 to receive a 2 inch locking pin 15. Vertical support member 40 is permanently affixed to crosspiece 20, with a plurality of through holes 48 drilled on opposing sides of vertical support member 40 along its vertical axis, parallel to crosspiece 20, and positioned to be aligned with through hole 58. Vertical support member 40 may then be adjusted to any height above the ground by matching through hole 58 to any of the various through holes 48, and inserting lock pin 15. Concomitantly, each pair of support arms 30 has a means of locking tire 1 to the support of the invention.

While the present description contains much specificity, this should not be construed as limitations on the scope of the invention, but rather as examples of some preferred embodiments thereof. For example, the apparatus has been described as constructed from generally rectangular or square cross-sectional steel. The cross-sectional shape should not be a limitation on the invention. Thus, cylindrical cross-sectional shapes are also contemplated to be within the scope of the invention. And, although welding is considered to produce a more sturdy structure, the parts of the invention could easily be designed by one of ordinary skill in the mechanical arts to be bolted tog ether. Accordingly, the scope of the invention should not be determined by the specific embodiments illustrated herein. The full scope of the invention is further illustrated by the claims appended hereto.

1. An apparatus for supporting a motorcycle, comprising
a. at least one pair of support arms for receiving a tire of at least one motorcycle;
b. a horizontal crosspiece for receiving the at least one pair of support arms; and
c. means for attaching the first horizontal crosspiece member to a structure.

2. The apparatus of claim 1 wherein the structure is a vehicle.

3. The apparatus of claim 2 additionally including a vertical support member affixed to the horizontal crosspiece.

4. The apparatus of claim 3 wherein the means for attaching the horizontal crosspiece to a structure comprises a horizontal support means affixed to the vertical support member, the horizontal support means sized for receipt in a trailer hitch.

5. The apparatus of claim 4 wherein the horizontal support means includes a vertical member sized to adjustably receive the vertical support member.

6. The apparatus of claim 1 additionally including locking means for securing the tire of the motorcycle to the apparatus for supporting the motorcycle.

7. The apparatus of claim 6 wherein the locking means comprises chain means affixed to the support arms.

8. The apparatus of claim 1 additionally including a second pair of support arms.

9. The apparatus of claim 1 wherein the structure is a post mounted in the ground.

10. The apparatus of claim 1 wherein the structure is a wall of a garage.

11. An apparatus for supporting a motorcycle, comprising
a. at least one pair of support arms for receiving a tire of at least one motorcycle;
b. a horizontal crosspiece for receiving the at least one pair of support arms;
c. a vertical support member affixed to the horizontal crosspiece, the vertical support means for supporting the tire; and
d. a horizontal support means affixed to the vertical support member, the horizontal support means sized for receipt in a trailer hitch.

12. The apparatus of claim 11 wherein the horizontal support means includes a vertical member sized to adjustably receive the vertical support member.

13. The apparatus of claim 11 additionally including locking means for securing the tire of the motorcycle to the apparatus for supporting the motorcycle.

14. The apparatus of claim 13 wherein the locking means comprises chain mean affixed to the support arms.

15. The apparatus of claim 11 additionally including a second pair of support arms.

16. The apparatus of claim 11 wherein the trailer hitch is attached to a post mounted in the ground.

17. The apparatus of claim 11 wherein the trailer hitch is attached to a wall of a garage.
